(19) United States
(12) Patent Application Publication
(10) Pub. No.: US 2009/0140048 A1
(43) Pub. Date: Jun. 4, 2009

(54) CPC Illumination Apparatus for an Imaging-Based Bar Code Reader

(75) Inventors: Ming Yu, South Setauket, NY (US); Rong Liu, Selden, NY (US); Duanfeng He, South Setauket, NY (US)

Correspondence Address: Tarolli, Sundheim, Covell & Tummino L.L.P, 1300 East Ninth Street, Suite 1700, Cleveland, OH, 44114, US

(73) Assignee: Symbol Technologies, Inc., Holtsville, NY (US)

(21) Appl. No.: 11/948,260

(22) Filed: Nov. 30, 2007

(51) Int. Cl. G06K 7/10

(52) U.S. Cl. 235/462.35

(57) ABSTRACT

An illumination apparatus for an imaging-based bar code reader having a field of view defined by an imaging system of the bar code reader directed toward a target bar code. The illumination apparatus includes: a collector cup comprising a compound parabolic concentrator and defining a longitudinal axis; an illumination source positioned to direct illumination toward a first end of the collector cup, the collector cup directing illumination from the illumination source toward a second end of the collector cup; a first lens array positioned at the second end of the collector cup orthogonal to the collector cup longitudinal axis to receive and focus illumination from the collector cup and a second lens array orthogonal to the collector cup longitudinal axis receiving focused illumination from the first lens array. The lens arrays combining to focus illumination from the collector cup into an illumination pattern.

### FIELD OF THE INVENTION

The present invention relates to an illumination apparatus for an imaging-based bar code reader and, more particularly, to an illumination apparatus for an imaging-based bar code reader including an illumination source providing visible illumination, a reflector cup surrounding the illumination source having an interior comprising a compound parabolic concentrator and a lens array integral with the reflector cup to focus the illumination in a well-defined, homogeneous pattern having sharp peripheral edges toward a target bar code.

### BACKGROUND ART

Various electro-optical systems have been developed for reading optical indicia, such as bar codes. A bar code is a coded pattern of graphical indicia comprised of a series of bars and spaces of varying widths, the bars and spaces having differing light reflecting characteristics. Some of the more popular bar code symbologies include: Universal Product Code (UPC), typically used in retail stores sales; Data Matrix, typically used for labeling small electronic products; Code 39, primarily used in inventory tracking; and Postnet, which is used for encoding zip codes for U.S. mail. Bar codes may be one dimensional (1D), i.e., a single row of graphical indicia such as a UPC bar code or two dimensional (2D), i.e., multiple rows of graphical indicia comprising a single bar code, such as Data Matrix which comprising multiple rows and columns of black and white square modules arranged in a square or rectangular pattern.

Systems that read bar codes (bar code readers) electro-optically transform the graphic indicia into electrical signals, which are decoded into alphanumerical characters that are intended to be descriptive of the article or some characteristic thereof. The characters are then typically represented in digital form and utilized as an input to a data processing system for various end-user applications such as point-of-sale processing, inventory control and the like.

Bar code readers that read and decode bar codes employing imaging systems are typically referred to as imaging-based bar code readers or bar code scanners. Imaging systems include charge coupled device (CCD) arrays, complementary metal oxide semiconductor (CMOS) arrays, or other imaging sensor arrays having a plurality of photosensitive elements (photosensors) defining image pixels. An illumination apparatus or system comprising light emitting diodes (LEDs) or other illumination or light source directs illumination toward a target object, e.g., a target bar code. Light reflected from the target bar code is focused through a system of one or more lens of the imaging system onto the pixel array. Thus, the target bar code within a field of view (FV) of the imaging lens system is focused on the sensor array.

Periodically, the pixels of the sensor array are sequentially read out generating an analog signal representative of a captured image frame. The analog signal is amplified by a gain factor and the amplified analog signal is digitized by an analog-to-digital converter. Decoding circuitry of the imaging system processes the digitized signals representative of the captured image frame and attempts to decode the imaged bar code.

As mentioned above, imaging-based bar code readers typically employ an illumination apparatus or system to flood a target object with illumination from an illumination or light source such as a light emitting diode (LED) in the reader. Light from the illumination source or LED is reflected from the target object. The reflected light is then focused through the imaging lens system onto the sensor array, the target object being within a field of view of the imaging lens system.

The illumination apparatus is designed to direct a pattern of illumination toward a target object such that the illumination pattern approximately matches the field of view (FV) of the imaging system. For many bar code imaging applications, the useful field of view FV is rectangular as determined by the sensor array's aspect ratio. The illumination pattern needs to cover the rectangular field of view FV with good uniformity and defined edges. Without using a focusing lens to direct the LED's illumination, the illumination pattern generally is a much wider pattern than necessary and, thus, wastes much of the generated illumination. Furthermore, the illumination pattern is generally not uniform and is without any defined illumination pattern edges.

A focusing lens is generally used to match the illumination pattern generated by the LED to the imaging system's field of view FV. Even with a focusing lens, it is difficult to generate a rectangular illumination pattern with sharp edges. Sharp edges for the illumination pattern is desirable especially when the illumination pattern is utilized as an aiming pattern to aid an operator in “aiming” the bar code reader at a target bar code when the bar code reader is used in a “point and shoot” method of operation.

To help alleviate this problem, prior art bar code readers typically including an aiming apparatus or system that projects a visible aiming illumination pattern (such as a visible “crosshair” pattern) that is generally congruent with a center of the imaging system field of view FV to facilitate properly aiming the bar code reader at a target bar code. While a visible aiming pattern is of help, such an aiming apparatus increases the cost of the imaging system and being an additional assembly increases the size or “footprint” of the imaging system camera assembly, both of which are disadvantageous. Further, a crosshair aiming pattern does not in many instances provide the user with a feel for the size of the field of view FV of the imaging system, that is, it does not mark or indicate the bounds of the field of view. Thus, if because of the position or location of the target bar code, the user is unable to align the crosshairs of the aiming pattern on the target bar code, the user will not know if the target bar code may is within the imaging system field of view FV and, therefore, capable of being successfully read (imaged & decoded).

What is needed is an illumination apparatus or system that generates a visible, well-defined illumination pattern that substantially conforms to the imaging system field of view FV thereby eliminating the need for an aiming pattern system.

### SUMMARY

In one aspect, the present invention features an illumination apparatus or system for an imaging-based bar code reader, the bar code reader including an imaging system defining a field of view projected from the reader toward a target bar code. The illumination apparatus includes: a collector cup comprising a compound parabolic concentrator and defining a longitudinal axis; an illumination source positioned to direct illumination toward a first end of the collector cup, the collector cup directing illumination from the illumination source toward a second end of the collector cup; a first lens array coupled to the collector cup and positioned at the second end of the collector cup orthogonal to the collector cup longitudinal axis to receive and focus illumination from the collector cup, the first lens array defining a plurality of substantially contiguous rectangular lens elements; and a second lens array orthogonal to the collector cup longitudinal axis and defining a plurality of substantially contiguous rectangular lens elements, the plurality of lens elements of the second lens array being aligned with corresponding lens elements of the first lens array to receive illumination from the first lens array, the first and second lens arrays combining to focus illumination from the collector cup into an illumination pattern projected toward the field of view of the imaging system.

In one exemplary embodiment, the collector cup and the first lens array comprise an integral single molded piece and illumination from the illumination source is directed to toward the second end by total internal reflectance. In another exemplary embodiment, the collector cup includes a mirrored inner surface and illumination from the illumination source is directed toward the second end by reflectance from the mirrored inner surface. In another exemplary embodiment, the second lens array is positioned at a focal point defined by the plurality of lens elements of the first lens array.

In one exemplary embodiment, the first lens assembly comprises a first side including a plurality of horizontally-oriented lenses and a second side including a plurality of vertically-oriented lenses, the horizontally-oriented lenses of the first side and the vertically-oriented lenses of the second side combining to define the plurality of substantially contiguous rectangular lens elements of the first lens array.

In one exemplary embodiment, the collector cup is substantially circular in cross section. In another exemplary embodiment, the collector cup is substantially rectangular in cross section.

In one exemplary embodiment, the illumination source comprises an LED generating illumination in the visible range. In one exemplary embodiment the first and second lens arrays are fabricated of a selected one of glass, acrylic, polycarbonate and thermoplastic. In one exemplary embodiment, the collector cup is fabricated of thermoplastic.

In one exemplary embodiment, the illumination pattern substantially corresponds to a size of the field of view at a best focus position of the imaging system.

In one aspect, the present invention features a bar code reader including an imaging system including a lens and a sensor array for focusing illumination from a target object onto the sensor array, the imaging system defining a field of view directed toward the target object; and an illumination apparatus for directing an illumination pattern toward the target object. The illumination apparatus includes: a collector cup comprising a compound parabolic concentrator and defining a longitudinal axis; an illumination source positioned to direct illumination toward a first end of the collector cup, the collector cup directing illumination from the illumination source toward a second end of the collector cup; a first lens array coupled to the collector cup and positioned at the second end of the collector cup orthogonal to the collector cup longitudinal axis to receive and focus illumination from the collector cup, the first lens array defining a plurality of substantially contiguous rectangular lens elements; and a second lens array orthogonal to the collector cup longitudinal axis and defining a plurality of substantially contiguous rectangular lens elements, the plurality of lens elements of the second lens array being aligned with corresponding lens elements of the first lens array to receive illumination from the first lens array, the first and second lens arrays combining to focus illumination from the collector cup into an illumination pattern projected toward the field of view of the imaging system.

In one exemplary embodiment, the collector cup and the first lens array comprise an integral single molded piece and illumination from the illumination source is directed to toward the second end by total internal reflectance. In another exemplary embodiment, the collector cup includes a mirrored inner surface and illumination from the illumination source is directed toward the second end by reflectance from the mirrored inner surface. In another exemplary embodiment, the second lens array is positioned at a focal point defined by the plurality of lens elements of the first lens array.

In one exemplary embodiment, the first lens assembly comprises a first side including a plurality of horizontally-oriented lenses and a second side includes a plurality of vertically-oriented lenses, the horizontally-oriented lenses of the first side and the vertically-oriented lenses of the second side combining to define the plurality of substantially contiguous rectangular lens elements of the first lens array.

In one exemplary embodiment, the collector cup is substantially circular in cross section. In another exemplary embodiment, the collector cup is substantially rectangular in cross section.

In one exemplary embodiment, the illumination source comprises an LED generating illumination in the visible range. In one exemplary embodiment the first and second lens arrays are fabricated of a selected one of glass, acrylic, polycarbonate and thermoplastic. In one exemplary embodiment, the collector cup is fabricated of thermoplastic.

In one exemplary embodiment, the illumination pattern substantially corresponds to a size of the field of view at a best focus position of the imaging system.

In one aspect, the present invention features an illumination apparatus for an imaging-based bar code reader having a field of view defined by an imaging system of the bar code reader directed toward a target bar code, the illumination apparatus includes: an illumination source positioned to direct illumination along a longitudinal axis toward a first lens array; the first lens array receiving and focusing illumination from the illumination source, the first lens array defining a plurality of substantially contiguous rectangular lens elements; and a second lens array orthogonal to the longitudinal axis and defining a plurality of substantially contiguous rectangular lens elements, the plurality of lens elements of the second lens array being aligned with corresponding lens elements of the plurality of lens elements of the first lens array to receive illumination from the first lens array, the second lens array spaced from the first lens array and positioned along a focal plane corresponding to focal points of the rectangular lens elements of the first lens array, the first and second lens arrays combining to focus illumination from the collector cup into an illumination pattern projected toward the field of view of the imaging system.

These and other objects, advantages, and features of the exemplary embodiments are described in detail in conjunction with the accompanying drawings.

### BRIEF DESCRIPTION OF THE DRAWINGS

The foregoing and other features and advantages of the present invention will become apparent to one skilled in the art to which the present invention relates upon consideration of the following description of the invention with reference to the accompanying drawings, in which:

FIG. 1 is a schematic side elevation view of an exemplary embodiment of an imaging-based bar code reader of the present invention;

FIG. 2 is a schematic front elevation view of the bar code reader of FIG. 1;

FIG. 3 is a schematic top plan view of the bar code reader of FIG. 1;

FIG. 4 is a schematic view partly in section and partly in side elevation of a camera assembly of an imaging assembly of the bar code reader of FIG. 1;

FIG. 5 is a schematic block diagram of the bar code reader of FIG. 1;

FIG. 6 is a schematic perspective view of a first embodiment of an illumination apparatus of the present invention;

FIG. 7 is a schematic side elevation view of the illumination apparatus of FIG. 6 as seen from a plane indicated by the line 7-7 in FIG. 6;

FIG. 7A is a perspective view of a portion of a first lens array of the illumination apparatus of FIG. 6 shown in the dashed line circled area of FIG. 7 looking from a view inside a collector cup of the illumination apparatus;

FIG. 7B is a front elevation view of the collector cup of the illumination apparatus of FIG. 6 showing an interior region comprising a compound parabolic concentrator (CPC);

FIG. 8 is a schematic top elevation view of the collector cup of the illumination apparatus of FIG. 6 as seen from a plane indicated by the line 8-8 in FIG. 6 showing the geometry of two horizontal parabolic mirror segments of a compound parabolic concentrator defining an interior of the collector cup;

FIG. 9 is a schematic top elevation view of a second lens array as seen from a plane indicated by the line 9-9 in FIG. 7;

FIG. 10 is a schematic front elevation view of the first lens array showing the alignment of the horizontal cylindrical lens elements on one side of the first lens array and vertical cylindrical lens elements on an opposite side of the first lens array, the combination effectively resulting in an array of rectangular lens elements;

FIG. 11 is a schematic perspective view of a second embodiment of an illumination apparatus of the present invention;

FIG. 12 is a schematic side elevation view of a portion of a first lens array of the illumination apparatus of FIG. 11 as seen from a plane indicated by the line 12-12 in FIG. 11;

FIG. 13 is a schematic top elevation view of a portion of the first lens array of the illumination apparatus of FIG. 11 as seen from a plane indicated by the line 13-13 in FIG. 11;

FIG. 13A is a schematic perspective view of a representative rectangular lens element of the first lens array;

FIG. 14 is a schematic front elevation view showing an alignment of an array of the rectangular lens elements of the first lens array and an array of rectangular lens elements of the second lens array, the second lens array including horizontal cylindrical lens elements on one side of the second lens array and vertical cylindrical lens elements on an opposite side of the second lens array, the combination effectively resulting in the array of rectangular lens elements of the second lens array;

FIG. 15 is a schematic representation of illumination intensity of the illumination pattern generated by the illumination apparatus of the present invention at a distance that generally corresponds to a best in-focus target plane of an imaging lens assembly of the bar code reader; and

FIG. 16 is a schematic representation of illumination intensity of the illumination pattern generated by the illumination apparatus of the present invention at a distance that is substantially beyond to the best in-focus target plane of the imaging lens assembly of the bar code reader.

### DETAILED DESCRIPTION

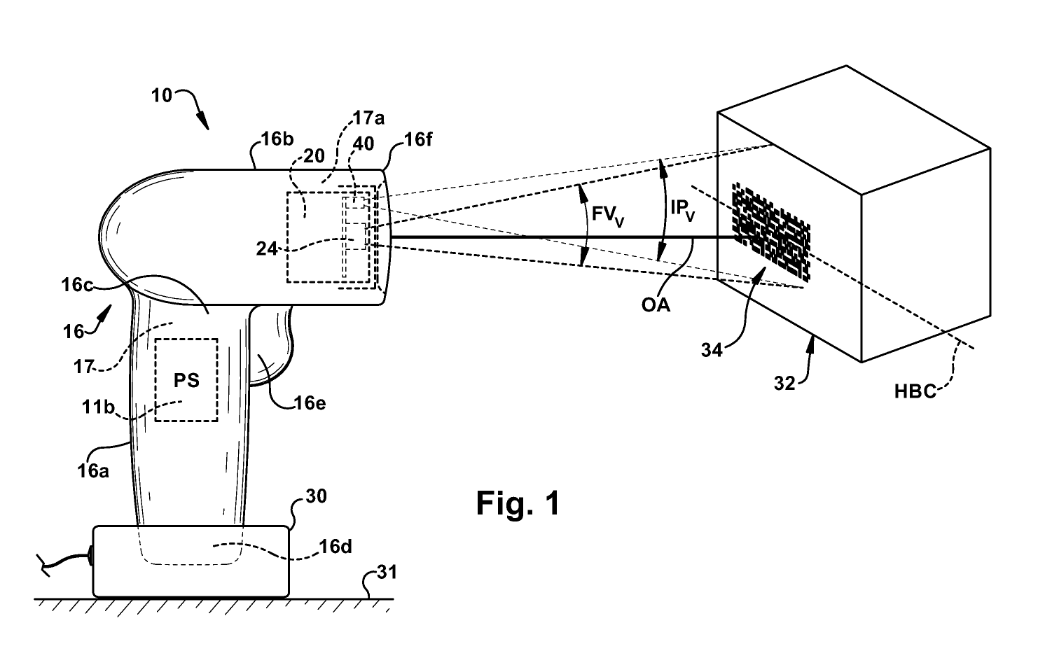

An exemplary embodiment of an imaging-based bar code reader of the present invention is shown schematically at 10 in FIGS. 1-5. The bar code reader 10 includes an imaging system 12 and a decoding system 14 mounted in a housing 16. The reader 10 is capable of reading, that is, imaging and decoding bar codes. The imaging system 12 is adapted to capture image frames of a field of view FV of the imaging system 12 and the decoding system 14 is adapted to decode encoded indicia within a captured image frame. The housing 16 supports circuitry 11 of the reader 10 including the imaging and decoding systems 12, 14 within an interior region 17 of the housing 16.

The imaging system 12 comprises a modular scan engine or imaging camera assembly 20 and associated imaging circuitry 22. The imaging camera assembly 20 includes a housing 24 supporting an imaging lens assembly 26, including one or more imaging lens, which focus illumination from the field of view FV onto a pixel or sensor array 28. The imaging lens assembly 26 includes a one or more imaging lens and an aperture stop. One suitable imaging lens assembly is disclosed in U.S. Ser. No. 11/731,835, filed Mar. 30, 2007 and entitled “Compact Imaging Lens Assembly for an Imaging-Based Bar Code Reader.” The '835 application is assigned to the assignee of the present invention and is incorporated herein in its entirety by reference.

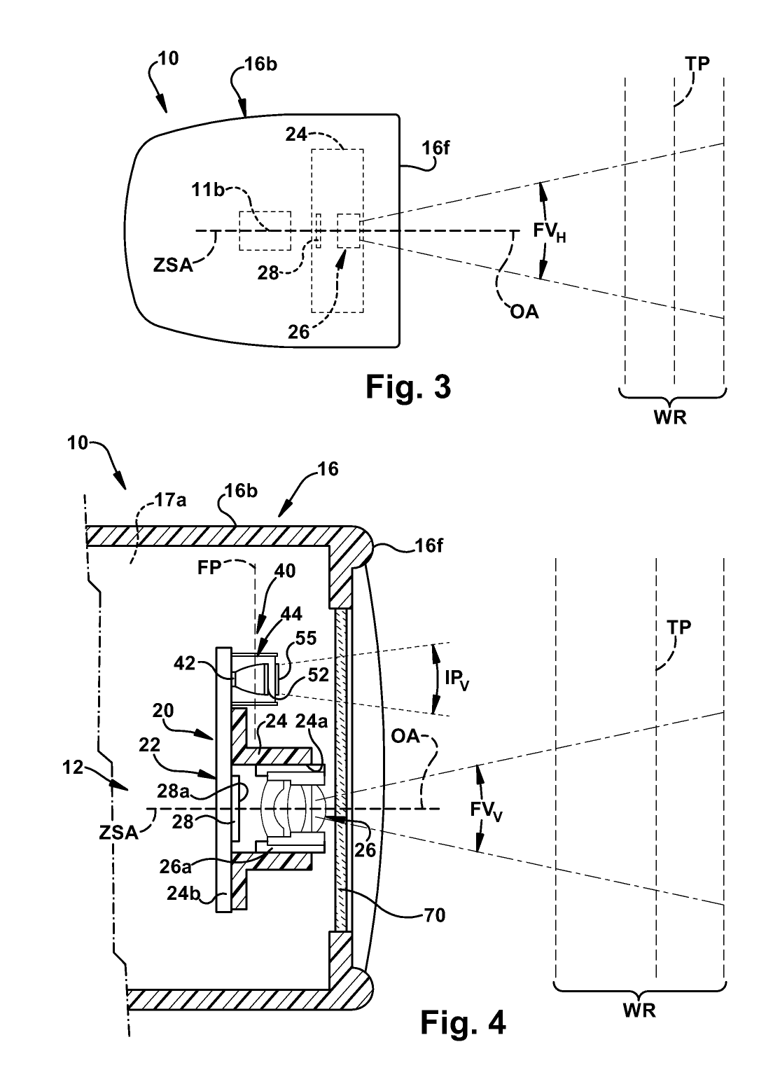

The sensor array 28 is enabled during an exposure period to capture an image of a target object 32 having a target bar code 34 within a field of view FV of the imaging system 12. The field of view FV of the imaging system 12 is a function of both the configuration of the sensor array 28 and the optical characteristics of the imaging lens assembly 26 and the distance and orientation between the array 28 and the imaging lens assembly 26. The imaging lens assembly 26 defines a best or most in-focus target plane TP (shown schematically FIGS. 3 and 4). The target plane TP is a plane orthogonal to an optical axis OA of the imaging lens assembly 26 and within the field of view FV of the imaging system 12 a distance in front of the reader 10 at which a target object 32 would be focused with the greatest clarity or resolution onto the sensor array 28. It should be appreciated that although the best in-focus target plane TP is fixed (for an fixed position imaging system), the depth of field or working range WR (shown schematically in FIGS. 3 and 4) for a given lens assembly allows decodable images to be captured from the target bar code 34 in a distance range about or surrounding the target plane TP. As is seen in FIG. 3 and 4 the working range WR envelopes the target plane TP. Of course, the working range WR is, among other things, dependent on the size and density of the target bar code 34, lighting conditions, characteristics of the imaging lens assembly 26 and sensor array 28.

In one exemplary embodiment, the imaging system 12 is a two dimensional (2D) imaging system and the sensor array 28 is a 2D sensor array. It should be understood, however, that the present invention is equally applicable to a linear or one dimensional imaging system having a 1D sensor array.

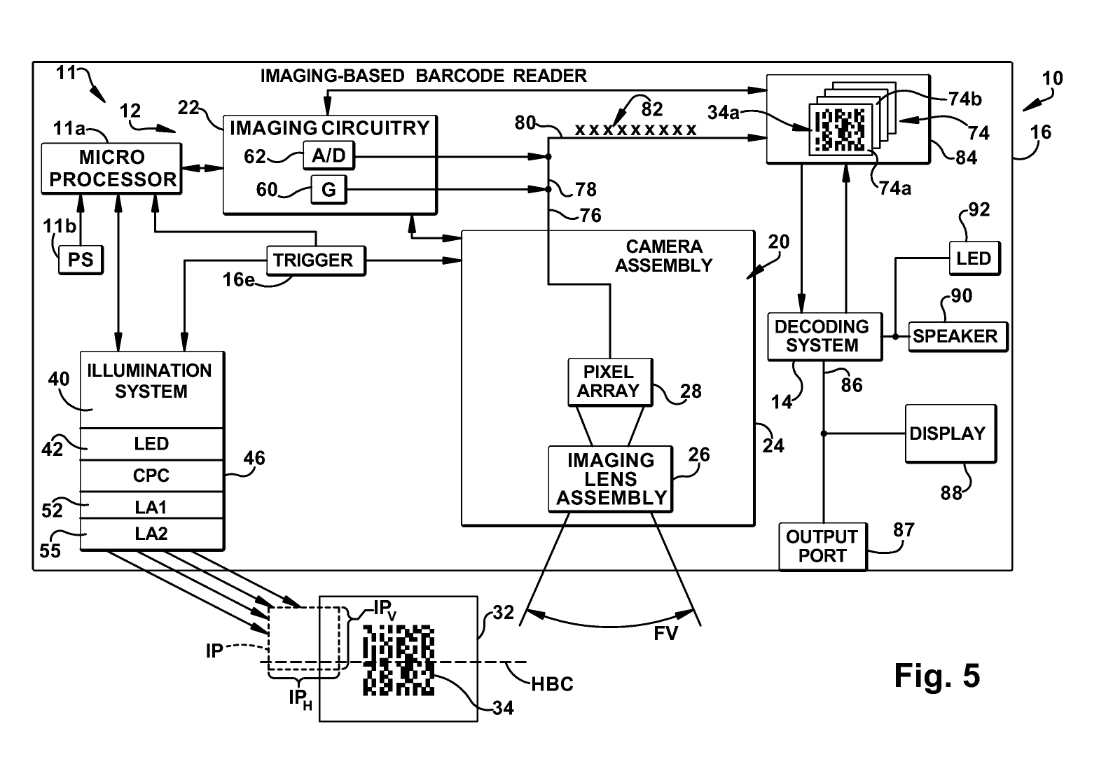

The imaging system 12 field of view FV (shown schematically in FIG. 5) includes both a horizontal and a vertical field of view, the horizontal field of view being shown schematically as FVH in FIG. 3 and the vertical field of view being shown schematically as FVV in FIGS. 1 and 4. The sensor array 28 is primarily adapted to image 1D and 2D bar codes, for example, the 2D bar code as shown in FIG. 1 which extends along a horizontal axis HBC and includes multiple rows of indicia comprising a multi-row, multi-column array of dark bars and white spaces. However, one of skill in the art would recognize that the present invention is also applicable to image postal codes, signatures, etc.

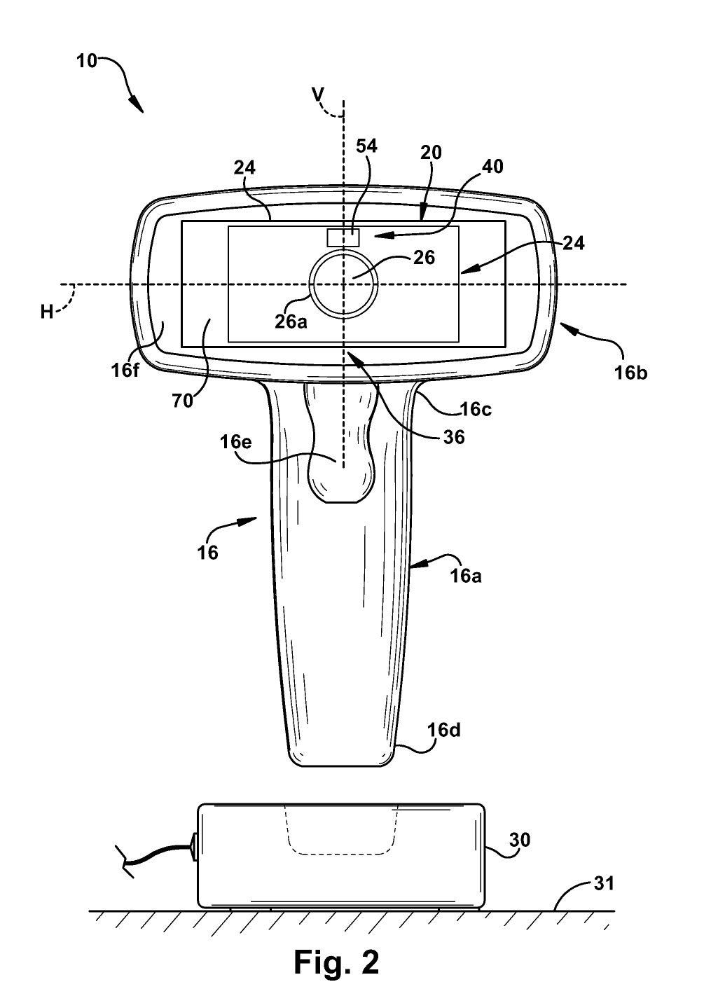

The housing 16 includes a gripping portion 16a adapted to be grasped by an operator's hand and a forward or scanning head portion 16b extending from an upper part 16c of the gripping portion 16a. A lower part 16d of the gripping portion 16a is adapted to be received in a docking station 30 positioned on a substrate 31 such as a table or sales counter. The scanning head 16b supports the imaging system 12 within an interior region 17a (FIG. 4) of the scanning head 16b. As can best be seen in FIG. 2, looking from the front of the housing 16, the scanning head 16b is generally rectangular in shape and defines a horizontal axis H and a vertical axis V. The vertical axis V being aligned with a general extent of the gripping portion 16a.

Advantageously, the reader 10 of the present invention is adapted to be used in both a hand-held mode and a fixed position mode. In the fixed position mode, the housing 16 is received in the docking station 30 and a target object 32 having a target bar code 34 (FIG. 1) is brought within the field of view FV of the reader's imaging system 12 in order to read, that is, image and decode an image of 34a (shown schematically in FIG. 5) of the target bar code 34. The imaging system 12 is typically always on or operational in the fixed position mode to image and decode any target bar code presented to the reader 10 within the field of view FV. The docking station 30 is plugged into an AC power source and provides regulated DC power to circuitry 11 of the reader 10. Thus, when the reader 10 is in the docking station 30 power is available to keep the imaging system 12 on continuously.

In the hand-held mode, the housing 14 is removed from the docking station 30 so the reader 10 can be carried by an operator or user and positioned such that the target bar code 34 is within the field of view FV of the imaging system 12. In the hand-held mode, an imaging session, that is, imaging and decoding of the target bar code 34, is initiated by the operator depressing a trigger 16e extending through an opening near the upper part 16c of the gripping portion 16a.

The imaging system 12 is part of the bar code reader circuitry 11 which may operate under the control of a microprocessor 11a (FIG. 5) or the microprocessor may be included within circuitry 22 of the imaging system 12. When removed from the docking station 30, power is supplied to the imaging and decoding systems 12, 14 by a power supply 11b.

The imaging system and decoding systems 12, 14 of the present invention may constitute a single integrated system or two systems. The imaging and decoding systems 12, 14 may be embodied in hardware, software, electrical circuitry, firmware embedded within the microprocessor 11a or the modular camera assembly 20, on flash read only memory (ROM), on an application specific integrated circuit (ASIC), or any combination thereof.

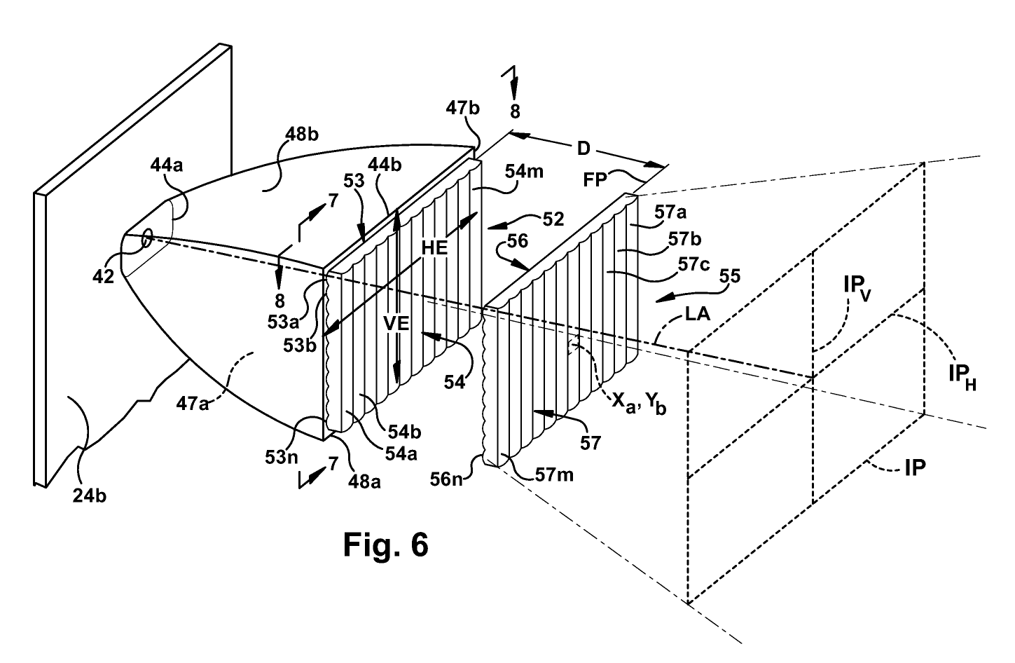

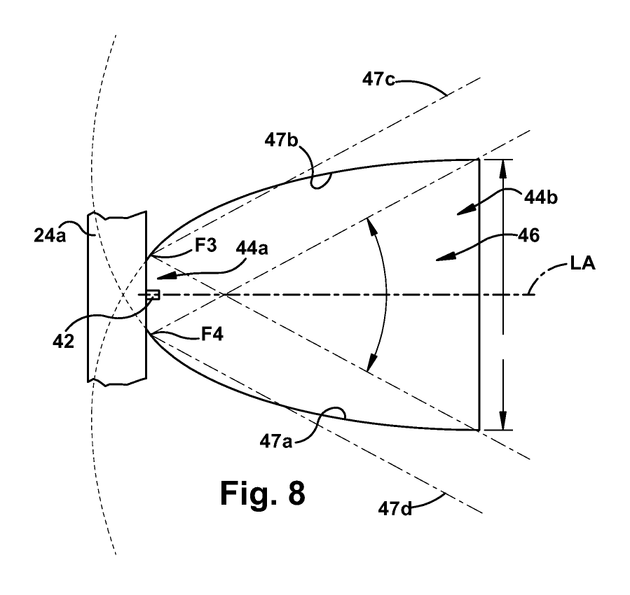

The bar code reader 10 of the present invention includes an illumination apparatus or system 40, described more fully below, to illuminate the target bar code 34 with visible illumination. Advantageously, as can be seen in FIG. 8, when viewed at a distance from the reader 10 that substantially corresponds to the best in-focus target plane TP of the imaging lens assembly 26, a visible illumination pattern IP generated by the illumination apparatus 40 is of maximum sharpness, that is, peripheral edges PE (FIG. 15) of the illumination pattern IP are of maximum sharpness and definition. Additionally, the imaging pattern IP at the best in-focus target plane TP substantially corresponds to the field of view FV of the imaging system 12. That is, at the best in-focus target plane TP, a horizontal extent (labeled IPH in FIG. 6) of the illumination pattern IP substantially corresponds to a horizontal extent of the horizontal field of view FVH and a vertical extent (labeled IPV in FIG. 6) of the illumination pattern IP substantially corresponds to a vertical extent of the vertical field of view FVV. Because of the sharpness of the illumination pattern IP and its correspondence to the imaging system field of view FV, the illumination pattern IP obviates the need for a separate aiming system for the reader 10 as the user of the reader can utilize the illumination pattern IP for aiming purposes and to judge the extent of the field of view FV of the imaging system 12.

The camera housing 24 is supported within the scanning head interior region 17a in proximity to a transparent window 70 (FIG. 4) defining a portion of a front wall 16f of the scanning head 16b. The window 70 is oriented such that its horizontal axis is substantially parallel to the scanning head horizontal axis H. The vertical axis of the window 70 may be tilted slightly to avoid a virtual image of the illumination assembly 40 from being within the field of view FV of the imaging system 12 or may be substantially parallel to the scanning head vertical axis V (as shown in FIG. 4) if having the virtual image does not degrade imaging system performance. Reflected light from the target bar code 34 passes through the transparent window 70, is received by the imaging lens assembly 26 and focused onto the imaging system sensor array 28. In one embodiment, the illumination apparatus 40 may be positioned behind the window 70, thus, illumination from the illumination apparatus 40 also passes through the window 70.

The imaging circuitry 22 may be disposed within, partially within, or external to the camera assembly housing 24. The imaging lens assembly 26 is supported by a lens holder 26a (FIG. 4). The camera housing 24 defines a front opening 24a that supports and seals against the lens holder 26a so that the only light incident upon the sensor array 28 is illumination passing through the imaging lens assembly 26.

In one preferred embodiment, the lens holder 26a is fixed with respect to the camera housing 24 in a fixed focus camera assembly. The lens holder 26a is typically made of metal or plastic. A back end of the housing 24 may be comprised of a printed circuit board 24b, which forms part of the imaging circuitry 22 and extends vertically to also support an illumination source 42, specifically, in one embodiment, a surface mounted LED of the illumination apparatus 40 (best seen in FIG. 4).

The imaging system 12 includes the sensor array 28 of the imaging camera assembly 20. The sensor array 28 comprises a charged coupled device (CCD), a complementary metal oxide semiconductor (CMOS), or other imaging pixel array, operating under the control of the imaging circuitry 22. In one exemplary embodiment, the sensor array 28 comprises a two dimensional (2D) mega pixel CMOS array with a typical size of the array being on the order of 1280×1024 pixels. Each pixel is comprised of a photosensitive element or photosensor that receives light and stores a charge proportional to the intensity of the light received and then is periodically discharged to generate an electrical signal whose magnitude is representative of the charge on the photosensitive element during an exposure period.

The illumination-receiving pixels of the sensor array 28 define a sensor array surface 28a (best seen in FIG. 4). The sensor array 28 is secured to the printed circuit board 24b, in parallel direction for stability. The sensor array surface 28a is substantially perpendicular to the optical axis OA of the imaging lens assembly 26, that is, a z axis (labeled ZSA in FIG. 4) that is perpendicular to the sensor array surface 28a would be substantially parallel to the optical axis OA of the imaging lens assembly 26. The pixels of the sensor array surface 28a are disposed substantially parallel to the horizontal axis H of the scanning head 16b.

As is best seen in FIG. 4, the imaging lens assembly lens 26 focuses light reflected and scattered from the target bar code 34 onto the sensor array surface 28a of the sensor array 28. Thus, the imaging lens assembly 26 focuses an image of the target bar code 34 (assuming it is within the field of view FV) onto the array of pixels comprising the pixel array 28. When actuated to read the target bar code 34, the imaging system 12 captures a series of image frames 74 (FIG. 5) which are stored in a memory 84. Assuming the bar code 34 is within the field of view FV of the imaging lens assembly 26, each image frame 74 includes the image 34a of the target bar code 34 (shown schematically in FIG. 5). The decoding system 14 decodes a digitized version of the image bar code 34a.

Electrical signals are generated by reading out of some or all of the pixels of the sensor array 28 after an exposure period. After the exposure time has elapsed, some or all of the pixels of sensor array 28 are successively read out thereby generating an analog signal 76 (FIG. 4). In some sensors, particularly CMOS sensors, all pixels of the sensor array 28 are not exposed at the same time, thus, reading out of some pixels may coincide in time with an exposure period for some other pixels.

The analog image signal 76 represents a sequence of photosensor voltage values, the magnitude of each value representing an intensity of the reflected light received by a photosensor/pixel during an exposure period. The analog signal 76 is amplified by a gain factor provided by gain circuitry 60, generating an amplified analog signal 78. The imaging circuitry 22 further includes an analog-to-digital (A/D) converter 62. The amplified analog signal 78 is digitized by the A/D converter 62 generating a digitized signal 80. The digitized signal 80 comprises a sequence of digital gray scale values 82 typically ranging from 0-255 (for an eight bit processor, i.e., 2⁸=256), where a 0 gray scale value would represent an absence of any reflected light received by a pixel during an exposure or integration period (characterized as low pixel brightness) and a 255 gray scale value would represent a very high intensity of reflected light received by a pixel during an exposure period (characterized as high pixel brightness).

The digitized gray scale values 82 of the digitized signal 80 are stored in the memory 84. The digital values 82 corresponding to a read out of the sensor array 28 constitute an image frame (say image frame 74a in FIG. 5), which is representative of the image projected by the focusing lens 26 onto the sensor array 28 during an exposure period. If the field of view FV of the imaging lens assembly 26 includes the target bar code 34, then the digital gray scale value image 34a of the target bar code 34 would be present in each image frame 74a, 74b, etc. of the series of image frames 74.

The decoding circuitry 14 then operates on the digitized gray scale values 82 of one or more selected image frame, say frame 74a, and attempts to decode any decodable image within the image frame, e.g., the imaged target bar code 34a. If the decoding is successful, decoded data 86, representative of the data/information coded in the bar code 34 is then output via a data output port 87 and/or displayed to a user of the reader 10 via a display 88. Upon achieving a good “read” of the bar code 34, that is, the imaged bar code 34a was successfully imaged and decoded, a speaker 90 and/or an indicator LED 92 is activated by the bar code reader circuitry 11 to indicate to the user that the target bar code 34 has successfully read, that is, the target bar code 34 has been successfully imaged and the imaged bar code 34a has been successfully decoded. If decoding is unsuccessful, a successive image frame, say image frame 74b, is selected and the decoding process is repeated until a successful decode is achieved.

### Illumination Apparatus 40

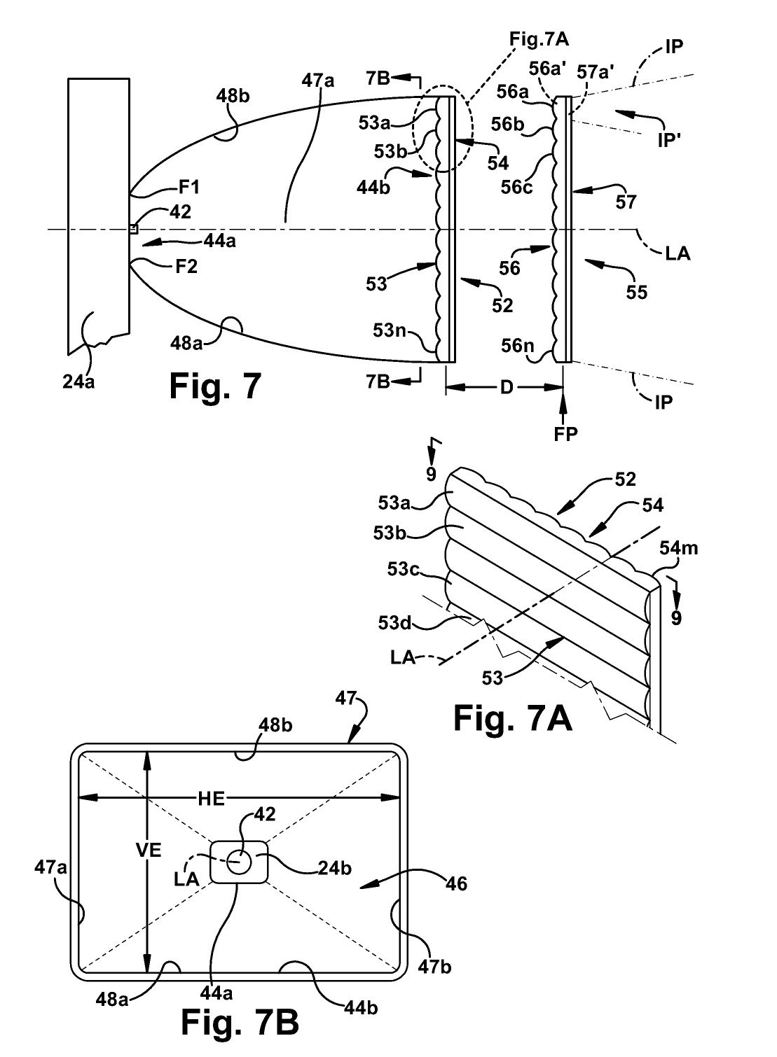

As can be seen in FIGS. 6 and 7, the illumination apparatus or system 40 of the present invention includes the illumination source 42, a collector cup 44 including an interior region defining a compound parabolic concentrator 46 (CPC) with a mirrored interior surface, a first lens array 52 positioned at an exit end 44b of the collector cup 44 and defining a plurality of contiguous rectangular lens elements, and a second lens array 55 defining a plurality of contiguous lens elements positioned at a focal point of the rectangular lens elements of the first lens array 52.

The illumination apparatus 40 directs or projects the illumination pattern IP toward the field of view FV of the imaging assembly 12 to illuminate the field of view to enhance imaging and decoding a target bar code 34 positioned within the field of view FV and within the working range WR of the imaging system 12. An aspect ratio illumination pattern IP, that is, a ratio of the horizontal extent IPH of the illumination pattern IP to the vertical extent IPV of the illumination pattern IP substantially corresponds to an aspect ratio of the imaging system field of view FV, namely, a ratio of the horizontal extent FVH of the field of view FV to the vertical extent FVV of the field of view FV.

Advantageously, the illumination pattern IP generated by the illumination apparatus 40 is homogenous illumination pattern having sharp, well-defined peripheral edges PE at the best in-focus target plane TP of the imaging system 12, as shown schematically in FIG. 15. That is, at the target plane TP, the illumination pattern IP has well-defined peripheral edges PE. Particularly advantageous is the fact that the illumination apparatus 40 of the present invention can easily be tailored to created an illumination pattern IP that corresponds to a small field of view FV which is very desirable in readers where there is a necessity of being able to read target bar codes at far distances, for example, 1 meter and beyond. Additionally, the illumination apparatus 40 of the present invention is robust with respect to mechanical tolerances and light source variation.

At distances closer than the target plane TP from the reader 10, the illumination pattern IP is less sharp or fuzzier around the peripheral edges PE, as shown schematically in FIG. 16. Moreover, the illumination apparatus 40 is configured such that at the best in-focus target plane TP, the illumination pattern IP is substantially congruent with, that is, overlies the field of view FV of the imaging lens assembly 26. Accordingly, assuming the illumination pattern IP includes light in the visible range, the illumination pattern may be advantageously used as an aiming pattern by the operator of the reader 19 to assist in pointing or aiming the reader at the target bar code 34 when used in the hand-held mode of operation.

The illumination source 42 may be a surface-mount LED, generating illumination in the visible spectrum so that the generated illumination pattern is visible to the operator or user of the reader 10. Alternately, the illumination source 42 may be a cold cathode lamp (CFL) or other suitable source of visible illumination known to those of skill in the art. The LED 42 may be mounted to the printed circuit board 24b. The collector cup 44 may be fabricated of any suitable material, such as, for example, metal or plastic material. The collector cup 44 has a first end or opening 44a that surrounds the LED 42 and a second opening 44b though which illumination exits the collector cup.

The interior region of the collector cup 44 comprises the CPC 46. In one exemplary embodiment, the interior CPC 46 is rectangular in cross sectional shape (best seen in FIG. 7B) comprising a vertically oriented pair of parabolic mirror segments 47a, 47b defining the vertical walls of the CPC 46 and horizontally oriented pair of parabolic mirror segments 48a, 48b defining the horizontal walls of the CPC.

Turning to FIG. 7, the parabolic shape of horizontally oriented mirror segment 48a, 48b can be seen. As is the case with a compound parabolic reflectors generally, in the CPC 46, the focus F1 of the parabolic mirror segment 48a lies on the parabolic mirror segment 48b, while the focus F2 of the parabolic mirror segment 48b lies on the parabolic mirror segment 48a. The two parabolic surfaces 48a, 48b are symmetrical with respect to a longitudinal axis of the CPC 46. As can be seen in FIG. 8, the same geometric relationships hold with respect to the vertically oriented parabolic mirror segments 47a, 47b. In the CPC 46, the focus F3 of the parabolic mirror segment 47a lies on the parabolic mirror segment 47b, while the focus F4 of the parabolic mirror segment 47b lies on the parabolic mirror segment 47a. The two parabolic surfaces 47a, 47b are symmetrical with respect to the longitudinal axis LA of the CPC 46. Additionally, the axis 47c of parabolic mirror segment 47a is shown for illustration purposes in FIG. 8 as is the axis 47d of the parabolic mirror segment 47b.

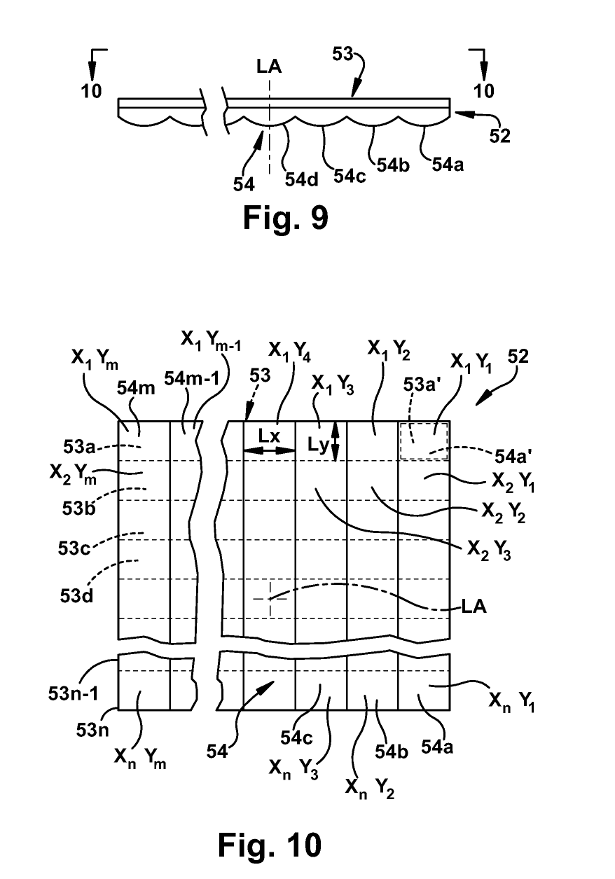

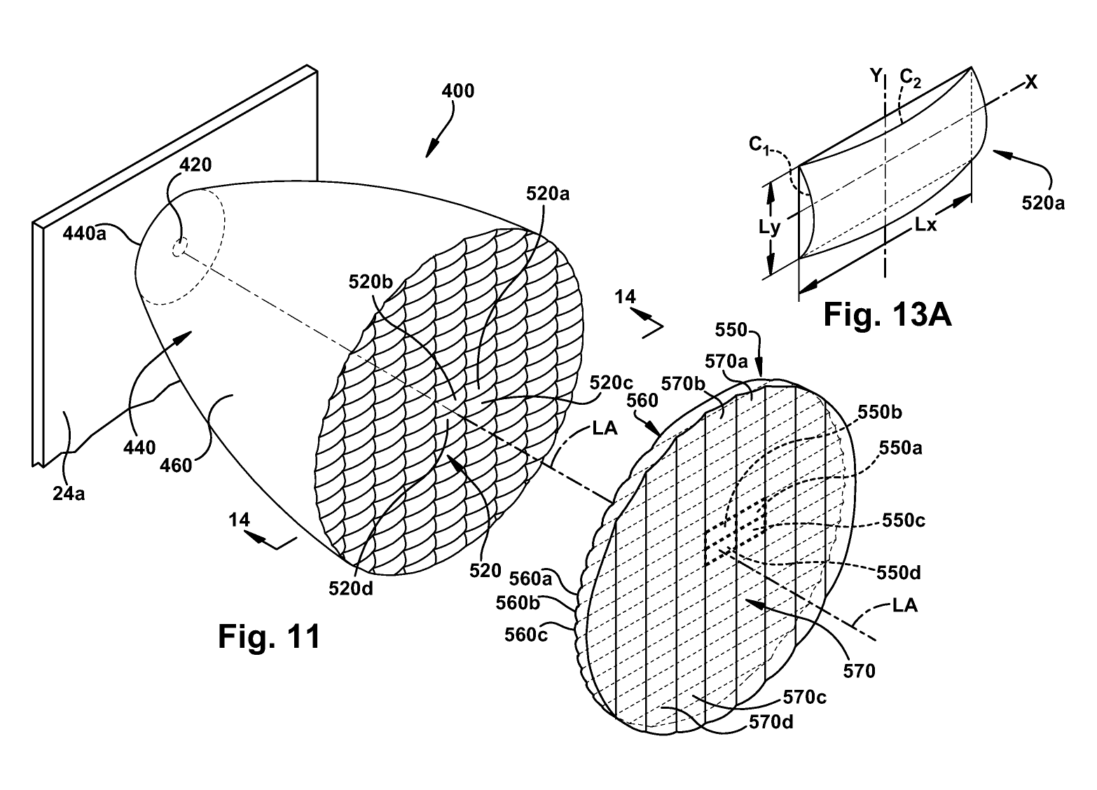

Advantageously, the CPC 46 exploits internal reflectance the mirror interior surfaces compound parabolic reflectors generally to transmit substantially all of the illumination generated by the LED 42 to the first lens array 52. Moreover, the angles of the light received by the first lens array 52 is desirably within an acceptance angle of the first and second lens arrays 52, 55, thus, substantially all illumination emitted by the CPC 46 is received by the first lens array 52 and focused by the lens arrays 52, 55 into the illumination pattern IP. It should be understood that while the embodiment shown in FIGS. 6-10, the interior region CPC 46 is rectangular in cross section. However, it should be recognized that the collector cup parabolic interior region 46 may be circular, as seen in FIG. 11. Generally, if a circular LED is used as the illumination source 42, then the interior region 46 of the collector cup 44 would be circular and if a rectangular LED is used, the interior region 46 would be rectangular. The idea is to select a shape of the collector cup that enhances efficiency of transmitting illumination from the illumination source 42 into the acceptance angle of the first and second lens arrays 52, 55, this is, illumination that ends up as part of the illumination pattern IP, and minimizes scattered light which is outside the acceptance angle and therefore ends up as stray light, not part of the illumination pattern IP.

Positioned at the second or exit end 44b of the collector cup 44 is the first lens array 52. The first lens array 52 is preferably fabricated to be affixed to or integral with the collector cup 44 so as to receive light generated by the LED 42 and directed to the exit opening 44b by the CPC 46. Preferably, the first and second lens arrays 52, 55 are fabricated from a suitable and lightweight lens material such as acrylic (PMMA), polycarbonate (PC) or high temperature thermoplastic.

As can best be seen in FIGS. 6, 7, 7A, the first lens array 52 comprises a side 53 facing the CPC 46 and the LED 42 and an opposite side 54 facing the second lens array 55 and the imaging system field of view FV. As best seen in FIG. 7A, the side 53 of the first lens array 52 comprises a plurality of substantially contiguous, horizontally-oriented cylindrical lens elements 53a, 53b, 53c, . . . , 53n extending between opposite vertical sides of the lens array 52. The opposite side 54 of the first lens array 52 comprises the plurality of substantially contiguous, vertically-oriented cylindrical lens elements 54a, 54b, 54c, . . . , 54m extending between the opposite horizontal sides of the lens array 52. The lens elements are contiguous, with each lens abutting its neighboring lens with no substantial gap between adjacent lens elements.

The exact number, size, and optical characteristics of the lens elements 53a, 53b, 53c, . . . , 53n, 54a, 54b, 54c, . . . , 54m will depend on the specifics of the illumination pattern IP desired to be generated, the optical characteristics of the second lens array 55 and the characteristics of the imaging system 26, including the size and shape of the field of view FV and the position of the best in-focus target plane TP.

The horizontally-oriented cylindrical lenses and vertically-oriented lens cylindrical lenses disposed on the first and second sides 53, 54 of the first lens array 52 are orthogonal and, when illumination passes through the first lens array 52, the horizontal and vertical lenses combine to effectively generate a matrix of contiguous, rectangular lenses, that can be viewed as a combination lens of overlapping portions of a horizontally-oriented lens and a vertically-oriented lens. For example, as can best be seen in FIG. 10, the overlapping portions of the horizontally-oriented cylindrical lens 53a and the vertically-oriented cylindrical lens 54a, when illumination passes through the first lens array 52, effectively form a rectangular combination lens X1Y1. Overlapping portions of horizontally-oriented cylindrical lens 53a and the vertically-oriented cylindrical lens 54b, when illumination passes through the first lens array 52, effectively form a rectangular combination lens X1Y2. Overlapping portions of horizontally-oriented cylindrical lens 53b and the vertically-oriented cylindrical lens 54b, when illumination passes through the first lens array 52, effectively form a rectangular combination lens X2Y2. Overlapping portions of horizontally-oriented cylindrical lens 53n and the vertically-oriented cylindrical lens 54m, when illumination passes through the first lens array 52, effectively form a rectangular combination lens XnYm. As is clear from FIG. 10, the orthogonal overlapping alignment with respect to the collector cup longitudinal axis LA of the horizontally-oriented lenses 53a, 53b, . . . , 53n and vertically oriented lenses 54a, 54b, . . . , 54m results in an n×m matrix of rectangular lenses. Each of the rectangular lenses X1Y1, X1Y2, . . . , X1Ym, X2Y1, X2Y2, . . . , X2Ym, . . . , XnY1, XnY2, . . . , XnYm is characterized by an aspect ratio of width Lx to height Ly that is substantially identical to the aspect ratio of the imaging system field of view FV, namely, the ratio of field of view horizontal FVH to field of view vertical FVV. The CPC 46 is configured such that an aspect ratio of the CPC 46 substantially matches an aspect ratio of the sensor array light receiving surface 28a and hence the horizontal/vertical ratio (FVH/FVV) of the field of view FV, that is, the ratio of the horizontal extent FVH and the vertical extent FVV of the field of view FV.

Each of the rectangular lens elements X1Y1, . . . , XnYm of the first lens array 52 are substantially identical and is characterized by a focal point extending forward of the first lens array 52, that is, toward the field of view FV. If all of the focal points of the rectangular lens elements of the first lens array 52 are determined, they will lie on a focal plane FP (FIG. 7) defined by the focal points. The second lens array 55 is positioned congruent with the focal points of the rectangular lens elements of the first lens array 52 and orthogonal to the axis LA. That is, the second lens array 55 is positioned along the focal plane FP defined by the first lens array 52 at a distance D (FIGS. 6 & 7) from the first lens array 52.

Looking at FIG. 10, an n×m matrix of lens elements results from the orthogonal relationship of the horizontally and vertically-oriented lenses of the opposite sides 53, 54. For example, the topmost horizontal cylindrical lens element 53a of the first side 53 is aligned with and orthogonal to upper portions of each of the vertical lens elements 54a, 54b, 54c, . . . , 54m of the second side 54. Thus, light from the LED 42 passing through and focused by a right hand portion 53a′ of the horizontal cylindrical lens element 53a (from the viewpoint seen in FIG. 10) is received by and focused by a top portion 54a′ of the vertical orthogonal cylindrical lens elements 54a. This corresponds to rectangular lens element X1Y1 in FIG. 10.

As can best be seen in FIGS. 6 and 7, the second lens array 55 comprises a first side 56 facing the imaging system field of view FV and an opposite side 57 facing the first lens array 52. The side 56 of the second lens array 55 comprises a plurality of substantially contiguous, horizontally-oriented cylindrical lens elements 56a, 56b, 56c, . . . , 56n extending between opposite vertical sides of the lens array 55. The opposite side 57 of the second lens array 55 comprises the plurality of substantially contiguous, vertically-oriented cylindrical lens elements 57a, 57b, 57c, . . . , 57m extending between the opposite horizontal sides of the lens array 55. The lens elements are contiguous, with each lens abutting its neighboring lens with no substantial gap between adjacent lens elements.

The exact number, size, and optical characteristics of the lens elements 56a, 56b, 56c, . . . , 56n, 57a, 57b, 57c, . . . , 57m will depend on the specifics of the illumination pattern IP desired to be generated, the optical characteristics of the second lens array 55 and the characteristics of the imaging system 26, including the size and shape of the field of view FV and the position of the best in-focus target plane TP.

As was the case with the first lens array 52, the horizontally-oriented cylindrical lenses and vertically-oriented lens cylindrical lenses disposed on the first and second sides 56, 57 of the second lens array 55 are orthogonal and, when illumination passes through the second lens array 55, the horizontal and vertical lenses combine to effectively generate a matrix of contiguous, rectangular lenses, that can be viewed as a combination lens of overlapping portions of a horizontally-oriented lens and a vertically-oriented lens. One representative rectangular lens of the second lens array 55 is shown in dashed line at XaYb in FIG. 6.

As was the case with the first lens array 52, an n×m matrix of lens elements results from the orthogonal relationship of the horizontally and vertically-oriented lenses of the opposite sides 56, 57. For example, the topmost horizontal cylindrical lens element 56a of the first side 56 is aligned with and orthogonal to upper portions of each of the vertical lens elements 57a, 57b, 57c . . . , 57m of the second side 57. Thus, light from the first lens array 52 passing through and focused by a right hand portion 56a′ of the horizontal cylindrical lens element 56a is received by and focused by a top portion 57a′ of the vertical orthogonal cylindrical lens elements 57a to generate an illumination pattern IP′ (shown schematically in FIG. 7). The illumination pattern IP′ is a component of the overall illumination pattern IP. A matrix of n×m such component illumination patterns are generated by the combined focusing of the first and second lens arrays 52, 55.

The first and second lens arrays 52, 55 combine to focus illumination from the collector cup CPC 46 into the illumination pattern IP projected toward the field of view FV of the imaging system 12. The use of two lens arrays 52, 55 insures that the resulting illumination pattern IP has very sharp peripheral edged PE at distances from the reader 10 of the target plane TP and beyond. Indeed, the use of two lens arrays 52, 55 advantageously results in a sharp illumination pattern at distances from the reader going to infinity. The lens elements of the first and second lens arrays 52, 55 are configured and oriented such that at the best in-focus target position TP, the illumination pattern IP substantially corresponds to the field of view FV of the imaging system 12.

The reflector cup CPC 46 can be thought of as concentrating most of the light generated by the LED 42 into a numerical aperture NA of the combined lens elements, such as combined lens element X1Y1 shown in FIG. 10. For a given combined lens element, the aperture in the horizontal or x direction is NAx and in the vertical or y direction is Nay. A small amount of light outside the numerical apertures of the will show up as stray light in the background on the target object 32, known as channel cross talk of the lens arrays 52, 54. The light within each combined lens element is homogenized and coupled into the rectangular illumination pattern IP as determined by the numerical apertures values NAx and NAy. The numerical aperture values NAx and Nay are equal to, respectively, NAx=Lx/(2 F) and Nay=Ly/(2 F) wherein Lx and Ly are the actual measured sizes horizontally and vertically of the individual combined lens elements (see FIG. 10 for Lx and Ly) and F is the focal length of the individual combined lens elements.

The collector cup 44 enhances the efficiency of the collection and transmission of light from the illumination source 42 into the acceptance angle of the first and second lens arrays 52, 55, that is, an angle within which illumination directed onto the first lens array 52 would be focused by the first lens array, directed to the second lens array 55 and ultimately focused to be part of the illumination pattern IP. Illumination directed onto the first lens array 52 outside the acceptance angle of the lens arrays is scattered and may disadvantageously end up as background illumination that detracts from the illumination pattern IP. Thus, the collector cup 44 insures that more generated illumination of the illumination source 42 actually ends up focused into the illumination pattern IP as opposed to being scattered and ending up as background stray light.

However, as an alternative, it should be recognized that if the illumination source 42 is constructed such that it appropriately directs its illumination into the acceptance angle of the lens arrays 52, 55, then the collector cup 42 may be deleted and the illumination source 42 positioned to direct illumination into the first lens array 52. For example, a dome-shaped LED that has an appropriately shaped dome to direct light in a forward direction into the acceptance angle of the lens arrays 52, 55 would be an appropriate illumination source 42 to allow the collector cup 42 to be eliminated.

### Alternate Exemplary Embodiment of Illumination Apparatus 400

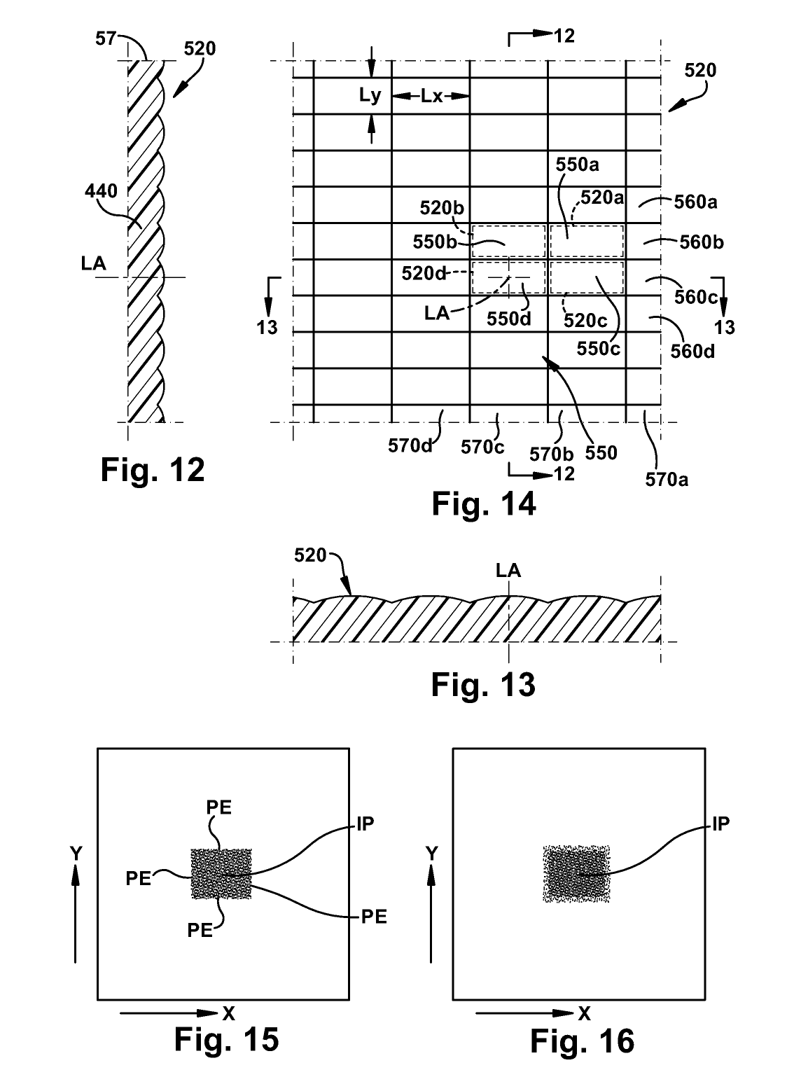

Another exemplary embodiment of the illumination system of the present invention is shown generally at 400 in FIGS. 11-14. In this embodiment, a collector cup 420 is mounted to the printed circuit board 24 of the camera assembly 20. The collector cup 420 includes a first end 440a that overlies a light source 420. The collector cup 420 and first lens array 520 are molded as a single piece of transparent plastic, for example, transparent thermoplastic. The collector cup 420 is circular in cross section and its outer surface 460 defines or is in the shape of a CPC. Because of the CPC shape of the outer surface 460, there is total internal reflection (TIR) of illumination emitted by the light source 420 within the collector cup 420. Because of the TIR, the collector cup 420 transmits illumination from the light source 420 to the first lens array 520 with substantially no loss of illumination.

The first lens array 520 is disposed at and defines a second end 440b of the collector cup 440. The first lens array 520 comprises an orthogonal array of contiguous rectangular lens elements for example, lens elements 520a, 520b, 520c, 520d, . . . . Each rectangular lens element includes a ratio of height (Ly) to width (Lx) that is substantially equal to an aspect ratio of the imaging system field of view FV, hence the aspect ratio of the illumination pattern IP matches the aspect ratio of the imaging system field of view FV.

Each of the lens elements 520a, 520b, 520c, 520d, . . . , comprises a pair of cylindrical surfaces. As can best be seen in FIG. 13A, for a representative lens element 520a, with respect to a horizontal axis X, the lens element has a cylindrical curvature corresponding to a curvature C1 and with respect to a vertical axis Y, the lens element has a cylindrical curvature corresponding to a shallower curvature C2, a radius of curvature of C1 being less than a radius of curvature of C2. The specific curvature values of C1 and C2 will be determined empirically depending on the desired illumination pattern IP, the position of the in-focus target plane TP, the optical characteristics of the second lens array 550, etc.

As can best be seen in FIG. 11, the second lens array 550 is positioned at a focal point FP of the lenses 520a, 520b, 520c, 520d, . . . of the first lens array 520. The second lens array 550 includes a plurality of horizontally-oriented cylindrical lens elements 560a, 560b, 560c, 560d, . . . , disposed on a first side 560 of the second lens array 550, facing the first lens array 520 and a plurality of vertically-oriented cylindrical lens elements 570a, 570b, 570c, 570d, . . . , disposed on a second side 570 of the second lens array 560, facing the field of view FV.

In essence, the horizontally-oriented cylindrical lens elements 53a, 53b, 53c, 53n of the first side 53 and vertically-oriented cylindrical lens 54a, 54b, 54c, . . . , 54m of the second side 54 of the first lens array 52 have been effectively combined onto a single substrate comprising contiguous rectangular lens 520a, 520b, 520c, 520d, . . . , of the first lens array 520. As would be recognized by one of skill in the art, the single lens array embodiment may be utilized with the rectangular cross section collector cup CPC described above in the first embodiment.

The horizontally-oriented cylindrical lenses and vertically-oriented lens cylindrical lenses disposed on the first and second sides 560, 570 of the second lens array 550 are orthogonal and, when illumination passes through the second lens array 550, the horizontal and vertical lenses combine to effectively generate a matrix of contiguous, rectangular combination lenses, for example, 550a, 550b, 550c, 550d, as shown in FIGS. 11 and 14 and as described with respect to the first embodiment. The rectangular lenses 550a, 550b, 550c, 550d of the second lens array 550 have an aspect ratio, that is, a ratio of width Lx to height Ly (FIG. 13A) that substantially corresponds to the aspect ratio of the imaging system field of view FV, namely, the ratio of field of view horizontal FVH to field of view vertical FVV.

Further, the rectangular lenses 520a, 520b, 520c, 520d of the first lens array 520 are substantially aligned with the rectangular lens 550a, 550b, 550c, 550d of the second lens array 550 with respect to the longitudinal axis LA of the collector cup 420. As can best be seen in FIG. 14, first and second lens arrays 520, 550 are substantially orthogonal to the longitudinal axis LD of the collector cup 420 and the rectangular lenses 520a, 520b, 520c, 520d of the first lens array 520 are substantially aligned with respective rectangular lenses 550a, 550b, 550c, 550d of the second lens array 550. Thus, illumination focused by lens 520a passes through and is further focused by aligned lens 550a to generate an illumination pattern that is a component of the overall illumination pattern IP, illumination focused by lens 520b passes through and is further focused by aligned lens 550b to generate an illumination pattern that is a component of the overall illumination pattern IP, etc. The first and second lens arrays 520, 550 thereby combine to focus illumination from the collector cup CPC 460 into the illumination pattern IP projected toward the field of view FV of the imaging system 12.

The lens elements of the first and second lens arrays 520, 550 are configured and oriented such that at the best in-focus target position TP, the illumination pattern IP substantially corresponds to the field of view FV of the imaging system 12.

It should be recognized that the first and second lens arrays 520, 550, instead of being spaced apart, may be combined into a single one-piece substrate, such as a molded thermoplastic substrate. Thus, the collector cup 440, the first lens array 520 and the second lens array 550 would be a single molded structure. In such an embodiment, the second lens array 550 would be a single-sided rectangular lens array like the first lens array 550. The first lens array 520 would be on a first side of the substrate facing the illumination source 42, while the second lens array 550 would be on an opposite side of the substrate facing the field of view FV. The distance between the first and second arrays 520, 550 would be determined by the focal points of the lens elements in the first array 520 given in the substrate medium, that is, the first and second lens arrays 520, 550 would be spaced apart by a focal point distance of the lens elements of the first array, as that distance would be in the substrate medium, e.g., the focal point distance in thermoplastic. Stated another way, the second lens array 550 would be positioned along a focal plane FP corresponding to focal points of the rectangular lens elements of the first lens array 550.

While the present invention has been described with a degree of particularity, it is the intent that the invention includes all modifications and alterations from the disclosed design falling with the spirit or scope of the appended claims.

We claim:

1. An illumination apparatus for an imaging-based bar code reader having a field of view defined by an imaging system of the bar code reader directed toward a target bar code, the illumination apparatus comprising:
a collector cup comprising a compound parabolic concentrator and defining a longitudinal axis;
an illumination source positioned to direct illumination toward a first end of the collector cup, the collector cup directing illumination from the illumination source toward a second end of the collector cup;
a first lens array coupled to the collector cup and positioned at the second end of the collector cup orthogonal to the collector cup longitudinal axis to receive and focus illumination from the collector cup, the first lens array defining a plurality of substantially contiguous rectangular lens elements; and
a second lens array orthogonal to the collector cup longitudinal axis and defining a plurality of substantially contiguous rectangular lens elements, the plurality of lens elements of the second lens array being aligned with corresponding lens elements of the first lens array to receive illumination from the first lens array, the first and second lens arrays combining to focus illumination from the collector cup into an illumination pattern projected toward the field of view of the imaging system.

2. The illumination apparatus of claim 1 wherein the collector cup and the first lens array comprise an integral single molded piece and illumination from the illumination source is directed to toward the second end by total internal reflectance.

3. The illumination apparatus of claim 1 wherein the collector cup includes a mirrored inner surface and illumination from the illumination source is directed toward the second end by reflectance from the mirrored inner surface.

4. The illumination apparatus of claim 1 wherein the second lens array is positioned at a focal point defined by the plurality of lens elements of the first lens array.

5. The illumination apparatus of claim 1 wherein the first lens assembly comprises two sides, a first side including a plurality of horizontally-oriented lenses and an second side including a plurality of vertically-oriented lenses, the horizontally-oriented lenses of the first side and the vertically-oriented lenses of the second side combining to define the plurality of substantially contiguous rectangular lens elements of the first lens array.

6. The illumination apparatus of claim 1 wherein the collector cup is substantially circular in cross section.

7. The illumination apparatus of claim 1 wherein the collector cup is substantially rectangular in cross section.

8. The illumination apparatus of claim 1 wherein the illumination source comprises an LED generating illumination in the visible range.

9. The illumination apparatus of claim 1 wherein the collector cup, first lens array and second lens array are fabricated as a single molded piece.

10. An imaging-based bar code reader comprising:
an imaging system including a lens and a sensor array for focusing illumination from a target object onto the photosensor array, the imaging system defining a field of view directed toward the target object; and
an illumination apparatus for directing an illumination pattern toward the target object and including:
a collector cup comprising a compound parabolic concentrator and defining a longitudinal axis;
an illumination source positioned to direct illumination toward a first end of the collector cup, the collector cup directing illumination from the illumination source toward a second end of the collector cup;
a first lens array coupled to the collector cup and positioned at the second end of the collector cup orthogonal to the collector cup longitudinal axis to receive and focus illumination from the collector cup, the first lens array defining a plurality of substantially contiguous rectangular lens elements; and
a second lens array orthogonal to the collector cup longitudinal axis and defining a plurality of substantially contiguous rectangular lens elements, the plurality of lens elements of the second lens array being aligned with corresponding lens elements of the first lens array to receive illumination from the first lens array, the first and second lens arrays combining to focus illumination from the collector cup into an illumination pattern projected toward the field of view of the imaging system.

11. The imaging-based bar code of claim 10 wherein the collector cup and the first lens array comprise an integral single molded piece and illumination from the illumination source is directed to toward the second end by total internal reflectance.

12. The imaging-based bar code of claim 10 wherein 3. The illumination apparatus of claim 1 wherein the collector cup includes a mirrored inner surface and illumination from the illumination source is directed toward the second end by reflectance from the mirrored inner surface.

13. The imaging-based bar code reader of claim 10 wherein the second lens array is positioned at a focal point defined by the plurality of lens elements of the first lens array.

14. The imaging-based bar code reader of claim 10 wherein the first lens assembly comprises two sides, a first side including a plurality of horizontally-oriented lenses and a second side comprising a plurality of vertically-oriented lenses, the horizontally-oriented lenses of the first side and the vertically-oriented lenses of the second side combining to define the plurality of substantially contiguous rectangular lens elements of the first lens array.

15. The imaging-based bar code reader of claim 10 wherein the collector cup is substantially circular in cross section.

16. The imaging-based bar code of claim 10 wherein the collector cup is substantially rectangular in cross section.

17. The imaging-based bar code of claim 10 wherein the illumination source comprises an LED generating illumination in the visible range.

18. The imaging-based bar code of claim 10 wherein the collector cup, first lens array and second lens array are fabricated as a single molded piece.

19. A method of imaging a target object, the steps of the method including:
providing an imaging system including a lens and a sensor array for focusing reflected illumination from a target object onto the photosensor array, the imaging system defining a field of view directed toward the target object;
providing an illumination apparatus including a collector cup comprising a compound parabolic concentrator and defining a longitudinal axis; an illumination source positioned to direct illumination into the collector cup, the collector cup directing illumination from the illumination source toward a second end of the collector cup;
a first lens array coupled to the collector cup and positioned at the second end of the collector cup orthogonal to the collector cup longitudinal axis to receive and focus illumination from the collector cup, the first lens array defining a plurality of substantially contiguous rectangular lens elements; and a second lens array orthogonal to the collector cup longitudinal axis and defining a plurality of substantially contiguous rectangular lens elements, the plurality of lens elements of the second lens array being aligned with corresponding lens elements of the first lens array to receive illumination from the first lens array, the first and second lens arrays combining to focus illumination from the collector cup into an illumination pattern projected toward the field of view of the imaging system; and
energizing the illumination system and the imaging system and imaging the target object.

20. An illumination apparatus for an imaging-based bar code reader including an imaging apparatus defining a field of view directed toward a target object, the illumination apparatus comprising:
a collector cup means a collector cup comprising a compound parabolic concentrator and defining a longitudinal axis;
an illumination source means directing illumination into a first end of the collector cup means, the collector cup means directing illumination from the illumination source toward a second end of the collector cup means;
a first lens array means positioned at the second end of the collector cup means orthogonal to the collector cup means longitudinal axis to receive and focus illumination from the collector cup means, the first lens array means including a plurality of substantially contiguous cylindrical lens elements facing the illumination source; and
a second lens array means orthogonal to the collector cup means longitudinal axis and including a plurality of substantially contiguous cylindrical lens elements facing toward the field of view, the plurality of lens elements of the second lens array means being orthogonal to and aligned with corresponding lens elements of the first lens array means to receive illumination from the first lens array, the first and second lens array means combining to focus illumination from the collector cup means into an illumination pattern projected toward the field of view of the imaging system.

21. An illumination apparatus for an imaging-based bar code reader having a field of view defined by an imaging system of the bar code reader directed toward a target bar code, the illumination apparatus comprising:
an illumination source positioned to direct illumination along a longitudinal axis toward a first lens array;
the first lens array receiving and focusing illumination from the illumination source, the first lens array defining a plurality of substantially contiguous rectangular lens elements; and
a second lens array orthogonal to the longitudinal axis and defining a plurality of substantially contiguous rectangular lens elements, the plurality of lens elements of the second lens array being aligned with corresponding lens elements of the plurality of lens elements of the first lens array to receive illumination from the first lens array, the second lens array spaced from the first lens array and positioned along a focal plane corresponding to focal points of the rectangular lens elements of the first lens array, the first and second lens arrays combining to focus illumination from the collector cup into an illumination pattern projected toward the field of view of the imaging system.
